(19) United States
(12) Patent Application Publication
(10) Pub. No.: US 2018/0314532 A1
(43) Pub. Date: Nov. 1, 2018

(54) ORGANIZING MESSAGES EXCHANGED IN HUMAN-TO-COMPUTER DIALOGS WITH AUTOMATED ASSISTANTS

(71) Applicant: Google Inc., Mountain View, CA (US)

(72) Inventor: Ibrahim Badr, Zurich (CH)

(21) Appl. No.: 15/498,173

(22) Filed: Apr. 26, 2017

(51) Int. Cl. G06F 9/44; G06F 3/0484; G06F 17/27; G06F 3/0481

(52) U.S. Cl. CPC G06F 9/4446; G06F 3/04817; G06F 17/2765; G06F 3/04842

(57) ABSTRACT

Techniques are described herein for organizing messages exchanged between users and automated assistants into distinct conversations. In various implementations, a chronological transcript of messages exchanged as part of human-to-computer dialog session(s) between a user and an automated assistant may be analyzed. Based on the analyzing, a subset of the chronological transcript of messages relating to a task performed by the user via the human-to-computer dialog session(s) may be identified. Based on content of the subset and the task, conversational metadata may be generated that causes a client computing device to provide a selectable element that conveys the task. Selection of the selectable element may cause the client computing device to present representations associated with at least one of the transcript messages related to the task.

### BACKGROUND

Humans may engage in human-to-computer dialogs with interactive software applications referred to herein as “automated assistants” (also referred to as “chatbots,” “interactive personal assistants,” “intelligent personal assistants,” “personal voice assistants,” “conversational agents,” etc.). For example, humans (which when they interact with automated assistants may be referred to as “users”) may provide commands, queries, and/or requests using spoken natural language input (i.e. utterances) which may in some cases be converted into text and then processed, and/or by providing textual (e.g., typed) natural language input. Users may engage automated assistants in a variety of distinct “conversations.” Each conversation may contain one or more individual messages that are semantically related to a particular topic, performance of a particular task, etc. In many instances, messages of a given conversation may be contained in a single human-to-computer dialog session between a user and an automated assistant. However, it is also possible that messages forming a conversation may span multiple sessions with an automated assistant.

As one example of a conversation, during a human-to-computer dialog session with an automated assistant, a user may submit a series of queries to the automated assistant that relate to making travel plans. Such queries (and the automated assistant's responses) may relate to, for instance, making transportation arrangements, learning about points of interest at or near a particular location, learning about events at or near a particular location, and so forth. In some cases, the user may procure one or more items related to their travel plans, such as tickets, vouchers, passes, travel-related products (e.g., sports equipment, luggage, clothing, etc.). As another example, a user may engage with an automated assistant to inquire about and/or respond to bills, notices, etc. In some instances, one or more users may engage with an automated assistant (and in some cases each other) to plan an event, such as a party, retreat, etc. Whatever task a user is performing while engaging an automated assistant, in many cases the task may have an outcome, such as procuring an item, scheduling an event, making an arrangement, etc.

The more a user engages with an automated assistant, the more messages between the user and the automated assistant (and other users as the case may be) may be persisted in a log. If a user wishes to revisit a prior conversation with the automated assistant, the user may have to pore through such a log to find individual messages that relate to the prior conversation. This can be especially difficult/tedious if a particular task performed by the user by engagement with the automated assistant occurred in the relatively distant past and/or over multiple distinct sessions between the user and the automated assistant. In the former case there may be a plethora of non-pertinent messages that have been persisted in the log since the user engaged the automated assistant in the prior conversation sought by the user. In the latter case there may be any number of intervening messages that are not pertinent to the prior conversation sought by the user.

### SUMMARY

Techniques are described herein for organizing messages exchanged as part of human-to-computer dialog sessions between users and automated assistants into clusters that represent distinct conversations between the users and the automated assistants. In some implementations, distinct clusters/conversations may be determined (e.g., delineated) based on tasks being performed by the users by way of engagement with the automated assistants. Additionally or alternatively, in some implementations, distinct clusters/conversations may be determined based on other signals, such as outcomes of tasks being performed by the users by way of engagement with the automated assistants, timestamps associated with individual messages (e.g., messages that occur close to each other temporally, especially within a single human-to-computer dialog session, may be presumed part of the same conversation between a user and an automated assistant), topics of conversation between the users and the automated assistants, and so forth.

In various implementations, so-called “conversational metadata” may be generated for each cluster of messages/conversation. Conversational metadata may include various information about the content of the conversation and/or the individual messages that form the conversation/cluster, such as the task being performed by the user while engaged with the automated assistant, the outcome of the task, a topic of the conversation, one or more times associated with the conversation (e.g., when the conversation started/ended, a duration of the conversation), how many separate human-to-computer dialog sessions the conversation spanned, who was involved in the conversation if it involved other participants besides a particular user, etc.

This conversational metadata may be generated in whole or in part at a client device operated by a user or remotely, e.g., at one or more server computers forming what is commonly referred to as a “cloud” computing system. In various implementations, the conversational metadata may be used by a client device such as a smart phone, tablet, etc., that is being operated by a user to present the organized clusters of messages to the user in an abbreviated manner that allows the user to quickly peruse/search distinct conversations for particular conversations of interest.

The manner in which the organized clusters/conversations are presented may be determined based on the conversational metadata referred to above. For example, selectable elements may be presented (e.g., visually) and in some cases may take the form of collapsed threads that, when selected, expand to provide the original messages that were selected as being part of the conversation/cluster. In some implementations, the selectable elements may convey various summary information about the conversations they represent, such as a task being performed (e.g., “Smart lightbulb research,” “Trip to Barcelona,” “Cooking stir fry,” etc.), an outcome of the task (e.g., “Procurement of item,” planned event details, etc.), a potential next action (e.g., “Finish booking your flight,” “procure smart light bulbs,” etc.), a topic of conversation (e.g., “research about George Washington,” “research about Spain,” etc.), and so forth. By presenting these selectable elements to the user in addition to or instead of presenting all past messages to the user, the user is able to quickly search and identify conversations of interest.

In some implementations, the selectable elements may be presented by themselves, without the underlying individual messages that make up the clusters on which the selectable elements are based. In other implementations, the selectable elements may be presented alongside and/or simultaneously with the underlying messages. For example, as a user scrolls through a log of past messages (e.g., transcripts of prior human-to-computer dialog sessions), selectable elements associated with conversations that are represented in whole or in part by the currently displayed messages may be provided. In some implementations, selectable elements may take the form of the messages themselves. For example, suppose a user selects a particular message in a past message log. Other messages that form part of the same conversation as the selected message may be highlighted or otherwise rendered in a conspicuous manner. In some implementations, a user may then be able to “toggle” through messages that relate to the same conversation (e.g., by pressing a button, operating a scroll wheel, etc.), while skipping intervening messages that do not form part of the same conversation.

In some implementations, a method performed by one or more processors is provided that includes: analyzing, by one or more processors, a chronological transcript of messages exchanged as part of one or more human-to-computer dialog sessions between at least one user and an automated assistant; identifying, by one or more of the processors, based on the analyzing, at least a subset of the chronological transcript of messages that relate to a task performed by the at least one user via the one or more human-to-computer dialog sessions; and generating, by one or more of the processors, based on content of the subset of the chronological transcript of messages and the task, conversational metadata associated with the subset of the chronological transcript of messages. In various implementations, the conversational metadata may cause a client computing device to provide, via an output device associated with the client computing device, a selectable element that conveys the task, wherein selection of the selectable element causes the client computing device to present, via the output device, representations associated with at least one of the transcript messages related to the task.

These and other implementations of technology disclosed herein may optionally include one or more of the following features.

In various implementations, the method may further include identifying, by one or more of the processors, based on content of the subset of the chronological transcript of messages, an outcome of the task. In various implementations, the selectable element may convey the outcome of the task. In various implementations, the method may further include identifying, by one or more of the processors, based on content of the subset of the chronological transcript of messages, a next step for completing the task. In various implementations, the selectable element may convey the next step. In various implementations, identifying the subset of the chronological transcript of messages may be based on an outcome of the task. In various implementations, the outcome of the task may include procurement of an item. In various implementations, the task may include organizing an event. In various implementations, the outcome of the task may include details associated with the organized event.

In various implementations, identifying the subset of the chronological transcript of messages may be based on timestamps associated with individual messages of the chronological transcript of messages. In various implementations, the selectable element may include a collapsible thread that expands on selection to provide the subset of the chronological transcript of messages. In various implementations, the selectable element may include an individual message of the subset, and selection of the individual message of the subset may cause one or more other individual messages of the subset to be presented in a first manner that is visually distinct from a second manner in which other messages of the chronological transcript of messages are presented.

In various implementations, the representations may include icons associated with or contained in the subset of the chronological transcript of messages. In various implementations, the representations may include one or more hyperlinks contained in the subset of the chronological transcript of messages. In various implementations, the representations may include the subset of the chronological transcript of messages. In various implementations, messages of the subset of the chronological transcript of messages may be presented chronologically. In various implementations, messages of the subset of the chronological transcript of messages may be presented in an order or relevance.

In addition, some implementations include one or more processors of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 is a block diagram of an example environment in which implementations disclosed herein may be implemented.

FIGS. 2A, 2B, 2C, and 2D depict example human-to-computer dialogs between various users and automated assistants, in accordance with various implementations.

FIGS. 2E, 2F, and 2G depict additional user interfaces that may be presented according to implementations disclosed herein.

FIG. 3 depicts an example method for performing selected aspects of the present disclosure.

FIG. 4 illustrates an example architecture of a computing device.

### DETAILED DESCRIPTION

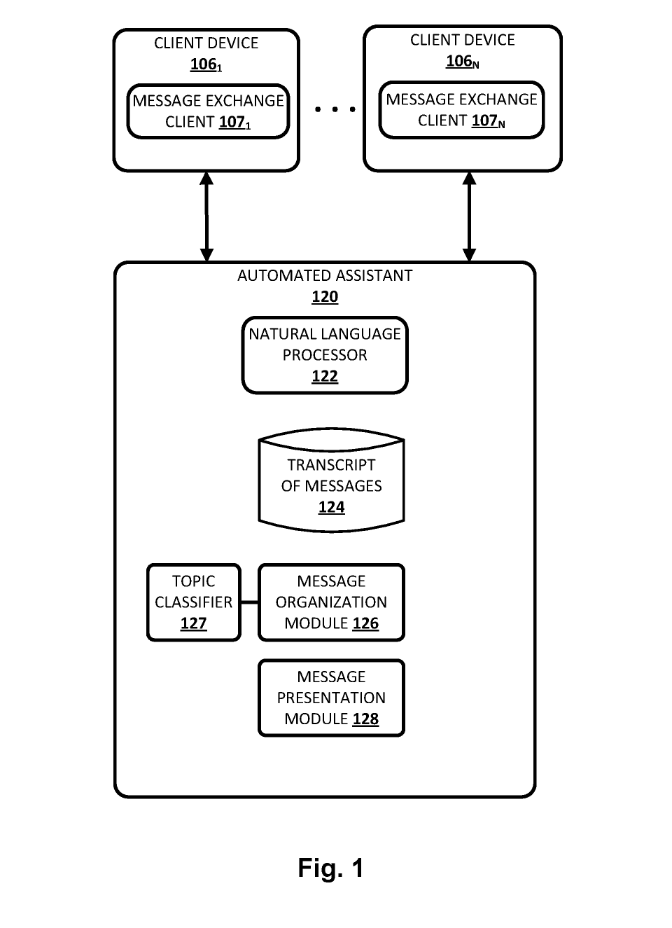

Now turning to FIG. 1, an example environment in which techniques disclosed herein may be implemented is illustrated. The example environment includes a plurality of client computing devices 106_{1-N} and an automated assistant 120. Although automated assistant 120 is illustrated in FIG. 1 as separate from the client computing devices 106_{1-N}, in some implementations all or aspects of the automated assistant 120 may be implemented by one or more of the client computing devices 106_{1-N}. For example, client device 106₁ may implement one instance of one or more aspects of automated assistant 120 and client device 106_{N} may also implement a separate instance of those one or more aspects of automated assistant 120. In implementations where one or more aspects of automated assistant 120 are implemented by one or more computing devices remote from client computing devices 106_{1-N}, the client computing devices 106_{1-N} and those aspects of automated assistant 120 may communicate via one or more networks such as a local area network (LAN) and/or wide area network (WAN) (e.g., the Internet).

The client devices 106_{1-N} may include, for example, one or more of: a desktop computing device, a laptop computing device, a tablet computing device, a mobile phone computing device, a computing device of a vehicle of the user (e.g., an in-vehicle communications system, an in-vehicle entertainment system, an in-vehicle navigation system), a standalone interactive speaker, a so-called “smart” television, and/or a wearable apparatus of the user that includes a computing device (e.g., a watch of the user having a computing device, glasses of the user having a computing device, a virtual or augmented reality computing device). Additional and/or alternative client computing devices may be provided. In some implementations, a given user may communicate with automated assistant 120 utilizing a plurality of client computing devices that collectively form a coordinated “ecosystem” of computing devices. In some such implementations, the automated assistant 120 may be considered to “serve” that particular user, e.g., endowing the automated assistant 120 with enhanced access to resources (e.g., content, documents, etc.) for which access is controlled by the “served” user. However, for the sake of brevity, some examples described in this specification will focus on a user operating a single client computing device 106.

Each of the client computing devices 106_{1-N} may operate a variety of different applications, such as a corresponding one of the message exchange clients 107_{1-N}. Message exchange clients 107_{1-N} may come in various forms and the forms may vary across the client computing devices 106_{1-N} and/or multiple forms may be operated on a single one of the client computing devices 106_{1-N}. In some implementations, one or more of the message exchange clients 107_{1-N} may come in the form of a short messaging service (“SMS”) and/or multimedia messaging service (“MMS”) client, an online chat client (e.g., instant messenger, Internet relay chat, or “IRC,” etc.), a messaging application associated with a social network, a personal assistant messaging service dedicated to conversations with automated assistant 120, and so forth. In some implementations, one or more of the message exchange clients 107_{1-N} may be implemented via a webpage or other resources rendered by a web browser (not depicted) or other application of client computing device 106.

As described in more detail herein, the automated assistant 120 engages in human-to-computer dialog sessions with one or more users via user interface input and output devices of one or more client devices 106_{1-N}. In some implementations, the automated assistant 120 may engage in a human-to-computer dialog session with a user in response to user interface input provided by the user via one or more user interface input devices of one of the client devices 106_{1-N}. For example, automated assistant 120 may generate responsive content in in response to free-form natural language input provided via one of the client devices 106_{1-N}. As used herein, free-form input is input that is formulated by a user and that is not constrained to a group of options presented for selection by the user.

In some implementations, the user interface input is explicitly directed to the automated assistant 120. For example, one of the message exchange clients 107_{1-N} may be a personal assistant messaging service dedicated to conversations with automated assistant 120 and user interface input provided via that personal assistant messaging service may be automatically provided to automated assistant 120. Also, for example, the user interface input may be explicitly directed to the automated assistant 120 in one or more of the message exchange clients 107_{1-N} based on particular user interface input that indicates the automated assistant 120 is to be invoked. For instance, the particular user interface input may be one or more typed characters (e.g., @AutomatedAssistant), user interaction with a hardware button and/or virtual button (e.g., a tap, a long tap), an oral command (e.g., “Hey Automated Assistant”), and/or other particular user interface input. In some implementations, the automated assistant 120 may engage in a dialog session in response to user interface input, even when that user interface input is not explicitly directed to the automated assistant 120. For example, the automated assistant 120 may examine the contents of user interface input and engage in a dialog session in response to certain terms being present in the user interface input and/or based on other cues. In many implementations, the automated assistant 120 may engage interactive voice response (“IVR”), such that the user can utter commands, searches, etc., and the automated assistant may utilize natural language processing and/or one or more grammars to convert the utterances into text, and respond to the text accordingly.

Each of the client computing devices 106_{1-N} and automated assistant 120 may include one or more memories for storage of data and software applications, one or more processors for accessing data and executing applications, and other components that facilitate communication over a network. The operations performed by one or more of the client computing devices 106_{1-N} and/or by the automated assistant 120 may be distributed across multiple computer systems. Automated assistant 120 may be implemented as, for example, computer programs running on one or more computers in one or more locations that are coupled to each other through a network.

Automated assistant 120 may include, among other things, a natural language processor 122, a message organization module 126, and a message presentation module 128. In some implementations, one or more of the engines and/or modules of automated assistant 120 may be omitted, combined, and/or implemented in a component that is separate from automated assistant 120.

As used herein, a “dialog session” may include a logically-self-contained exchange of one or more messages between a user and the automated assistant 120. The automated assistant 120 may differentiate between multiple dialog sessions with a user based on various signals, such as passage of time between sessions, change of user context (e.g., location, before/during/after a scheduled meeting, etc.) between sessions, detection of one or more intervening interactions between the user and a client device other than dialog between the user and the automated assistant (e.g., the user switches applications for a while, the user walks away from then later returns to a standalone voice-activated speaker), locking/sleeping of the client device between sessions, change of client devices used to interface with one or more instances of the automated assistant 120, and so forth.

In some implementations, when the automated assistant 120 provides a prompt that solicits user feedback, the automated assistant 120 may preemptively activate one or more components of the client device (via which the prompt is provided) that are configured to process user interface input to be received in response to the prompt. For example, where the user interface input is to be provided via a microphone of the client device 106₁, the automated assistant 120 may provide one or more commands to cause: the microphone to be preemptively “opened” (thereby preventing the need to hit an interface element or speak a “hot word” to open the microphone), a local speech to text processor of the client device 106₁ to be preemptively activated, a communications session between the client device 106₁ and a remote speech to text processor to be preemptively established, and/or a graphical user interface to be rendered on the client device 106₁ (e.g., an interface that includes one or more selectable elements that may be selected to provide feedback). This may enable the user interface input to be provided and/or processed more quickly than if the components were not preemptively activated.

Natural language processor 122 of automated assistant 120 processes natural language input generated by users via client devices 106_{1-N} and may generate annotated output for use by one or more other components of the automated assistant 120 (including components not depicted in FIG. 1). For example, the natural language processor 122 may process natural language free-form input that is generated by a user via one or more user interface input devices of client device 106₁. The generated annotated output includes one or more annotations of the natural language input and optionally one or more (e.g., all) of the terms of the natural language input.

In some implementations, the natural language processor 122 is configured to identify and annotate various types of grammatical information in natural language input. For example, the natural language processor 122 may include a part of speech tagger configured to annotate terms with their grammatical roles. For example, the part of speech tagger may tag each term with its part of speech such as “noun,” “verb,” “adjective,” “pronoun,” etc. Also, for example, in some implementations the natural language processor 122 may additionally and/or alternatively include a dependency parser configured to determine syntactic relationships between terms in natural language input. For example, the dependency parser may determine which terms modify other terms, subjects and verbs of sentences, and so forth (e.g., a parse tree)—and may make annotations of such dependencies.

In some implementations, the natural language processor 122 may additionally and/or alternatively include an entity tagger configured to annotate entity references in one or more segments such as references to people (including, for instance, literary characters), organizations, locations (real and imaginary), and so forth. The entity tagger may annotate references to an entity at a high level of granularity (e.g., to enable identification of all references to an entity class such as people) and/or a lower level of granularity (e.g., to enable identification of all references to a particular entity such as a particular person). The entity tagger may rely on content of the natural language input to resolve a particular entity and/or may optionally communicate with a knowledge graph or other entity database to resolve a particular entity.

In some implementations, the natural language processor 122 may additionally and/or alternatively include a coreference resolver configured to group, or “cluster,” references to the same entity based on one or more contextual cues. For example, the coreference resolver may be utilized to resolve the term “there” to “Hypothetical Café” in the natural language input “I liked Hypothetical Café last time we ate there.”

In some implementations, one or more components of the natural language processor 122 may rely on annotations from one or more other components of the natural language processor 122. For example, in some implementations the named entity tagger may rely on annotations from the coreference resolver and/or dependency parser in annotating all mentions to a particular entity. Also, for example, in some implementations the coreference resolver may rely on annotations from the dependency parser in clustering references to the same entity. In some implementations, in processing a particular natural language input, one or more components of the natural language processor 122 may use related prior input and/or other related data outside of the particular natural language input to determine one or more annotations.

Message organization module 126 may have access to an archive, log, or transcript(s) of messages 124 previously exchanged between one or more users and automated assistant 120. In some implementations, the transcript of messages 124 may be stored as a chronological transcript of messages. Consequently, a user wishing to find a particular message or messages from a past conversation the use had with automated assistant 120 may be required to scroll through a potentially large number of messages. The more the user (or multiple users) interact with automated assistant 120, the longer the chronological transcript of message 124 may be, which in turn makes it more difficult and tedious to locate past messages/conversations of interest. Alternatively, the user may be able to perform a keyword search (e.g., using a search bar) to locate particular messages. However, if the conversation of interest occurred a relatively long time ago, the user may not remember what keywords to search, and there may have been intervening conversations that also contain the keyword.

Accordingly, in various implementations, message organization module 126 may be configured to analyze chronological transcript of messages 124 exchanged as part of one or more human-to-computer dialog sessions between one or more users and automated assistant 120. Based on the analysis, message organization module 126 may be configured to group chronological transcript of messages 124 into one or more message subsets (or message “clusters”). Each subset or cluster may contain messages that are syntactically and/or semantically related, e.g., as a self-contained conversation.

In some implementations, each subset or cluster may relate to a task performed by the one or more users via one or more human-to-computer dialog sessions with automated assistant 120. For example, suppose one or more users exchanged messages with automated assistant 120 (and each other in some cases) to organize an event, such as a party. Those messages may be clustered together, e.g., by message organization module 126, as part of a conversation related to the task of organizing the party. As another example, suppose a user engages in a human-to-computer dialog with automated assistant 120 to research and ultimately procure a plane ticket. In various implementations, those messages may be clustered together, e.g., by message organization module 126, as part of another conversation related to the task of researching and procuring the plane ticket. Similar clusters or subsets of messages may be identified, e.g., by message organization module 126, as relating to any number of tasks, such as procuring items (e.g., products, services), setting and responding to a reminder, etc.

Additionally or alternatively, in some implementations, each subset or cluster may relate to a topic discussed during one or more human-to-computer dialog sessions with automated assistant 120. For example, suppose one or more users engage in one or more human-to-computer dialog sessions with automated assistant 120 to research Ronald Reagan. In various implementations, those messages may be clustered together, e.g., by message organization module 126, as part of a conversation related to the topic of Ronald Reagan. Topics of conversation may be identified in some implementations using a topic classifier 127 that is associated with (e.g., part of, employed by, etc.) message organization module 126. For example, topic classifier 127 may use a topic model (e.g., a statistical model) to cluster related words together and determine topics based on these clusters.

In various implementations, message organization module 126 may be configured to generate, based on content of each message subset of the chronological transcript of messages 124, so-called “conversational metadata” to be associated with each message subset. In some implementations, conversational metadata associated with a particular message subset may take the form of a data structure stored in memory that includes one or more fields for a task (or topic), one or more fields (e.g., identifiers or pointers) that are useable to identify individual messages that form part of the message subset, etc.

In various implementations, message presentation module 128 (which in other implementations may be integral with message organization module 126) may be configured to obtain conversational metadata from message organization module 126 and, based on that conversational metadata, generate information that causes a client computing device 106 to provide, via an output device (not depicted) associated with the client computing device, a selectable element. In various implementations, the selectable element may convey various aspects of the task, such as the task itself, an outcome of the task, next potential step(s), a goal of the task, topic, and/or other pertinent conversation details (e.g., event time/date/location, price paid, bill paid, etc.). To this end, in some implementations, the conversational metadata may be encoded, e.g., by message presentation module 128, using markup languages such as the Extensible Markup Language (“XML”) or the Hypertext Markup Language (“HTML”), although this is not required. As will be described below in more detail, the selectable element presented on client device 106 may take various forms, such as one or more graphical “cards” that are presented on a display screen, one or options presented audibly via a speaker (from which the user can select audibly), one or more collapsible message threads, etc.

In various implementations, selection of the selectable element may cause the client computing device 106 to present, via one or more output devices (e.g., a display), representations associated with at least one of the transcript messages related to the task. For example, in some implementations in which the selectable element comprises a collapsed thread, selection of the selectable element may toggle the collapsible thread between a collapsed state in which only a select few pieces of information (e.g., task, topic, etc.) are presented and an expanded state in which one or more messages of the message subset are visible. In some implementations, collapsible threads may include multiple levels, e.g., similar to a tree, in which responses to certain messages (e.g., from another user or from automated assistant 120) are collapsible beneath a statement from a user.

In other implementations, selection of the selectable element may simply open chronological transcript of messages 124, e.g., viewable on a display of client device 106, and automatically scan to the first message forming the conversation represented by the selectable element. In some implementations, only those messages forming part of the conversation represented by the selectable element will be presented. In other implementations, all message of chronological message exchange transcript 124 may be presented, and messages of the conversation represented by the selectable element may be rendered more conspicuously, e.g., in a different color, highlighted, bolded, etc. In some implementations, a user may be able to “toggle” through messages of the conversation represented by the selectable element, e.g., by selecting up/down arrows, “next”/“previous” buttons, etc. If there are other intervening messages interspersed among messages of the conversation of interest, in some implementations, those intervening messages may be skipped.

In some implementations, selection of a selectable element representing a conversation may cause links (e.g., hyperlinks, so-called “deep links”) that were contained in messages of the conversation to be displayed, e.g., as a list. In this way, a user can quickly tap on a conversation's representative selectable element to see what links were mentioned in the conversation, e.g., by the user, by automated assistant 120, and/or by other participants in the conversation. Additionally or alternatively, selection of a selectable element may only cause messages from automated assistant 120 to be presented, with messages from the user being omitted or rendered far less conspicuously. Providing these so-called “highlights” of past conversations may provide a technical advantage of allowing users—particularly those with limited abilities to provide input (e.g., disabled users, users who are driving or otherwise occupied, etc.)—to see portions (e.g., messages) of past conversations that were most likely to be of interest, while messages that are likely of less interest are omitted or presented less conspicuously.

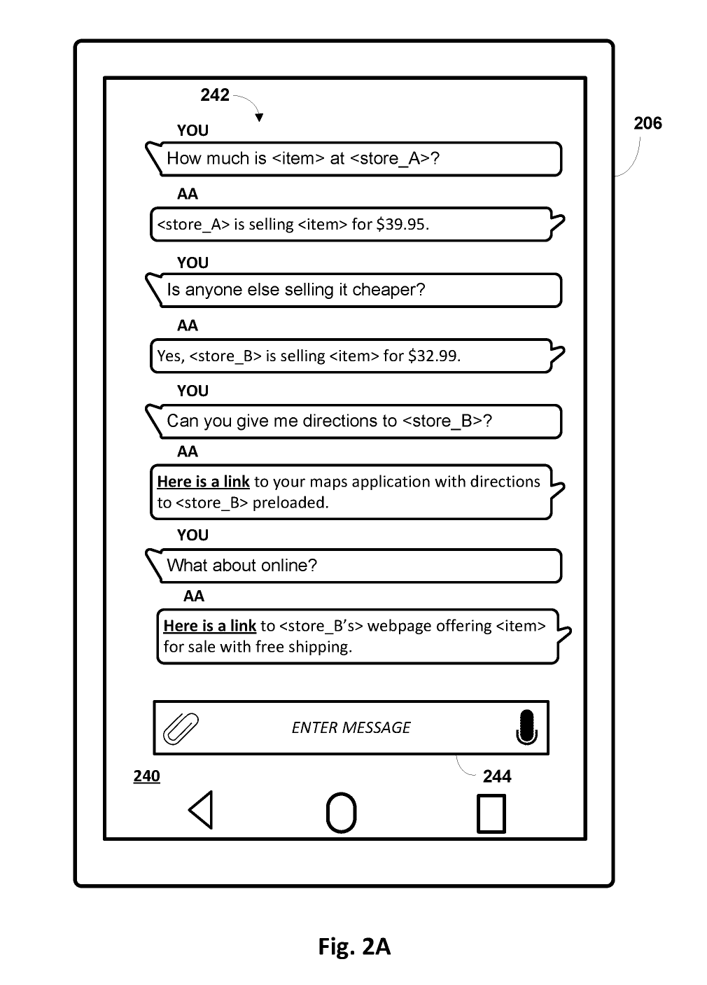

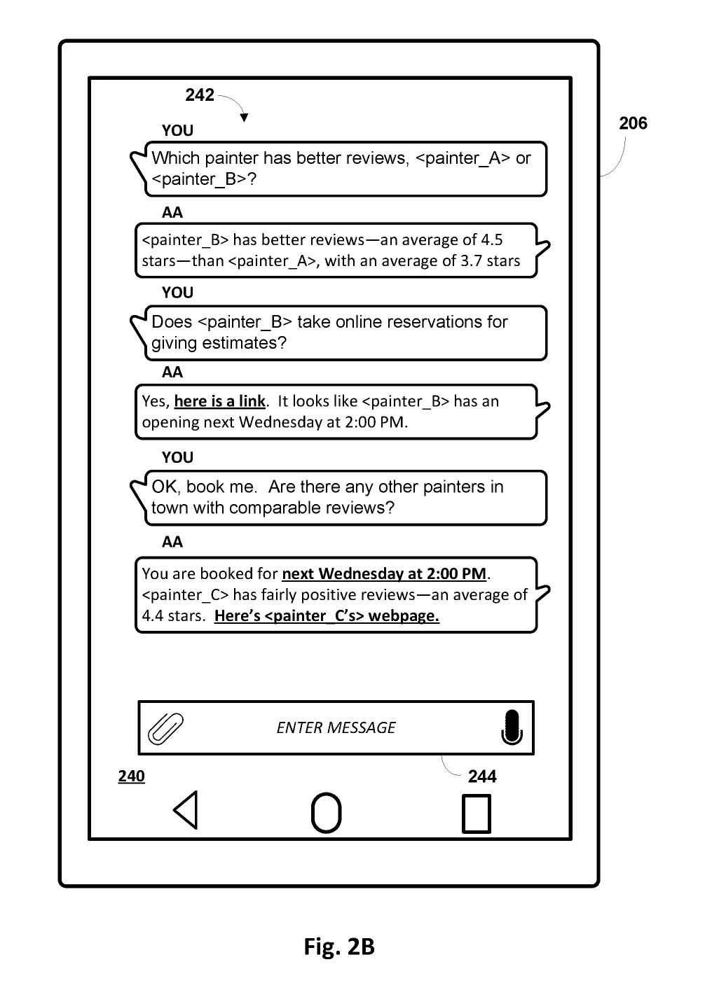

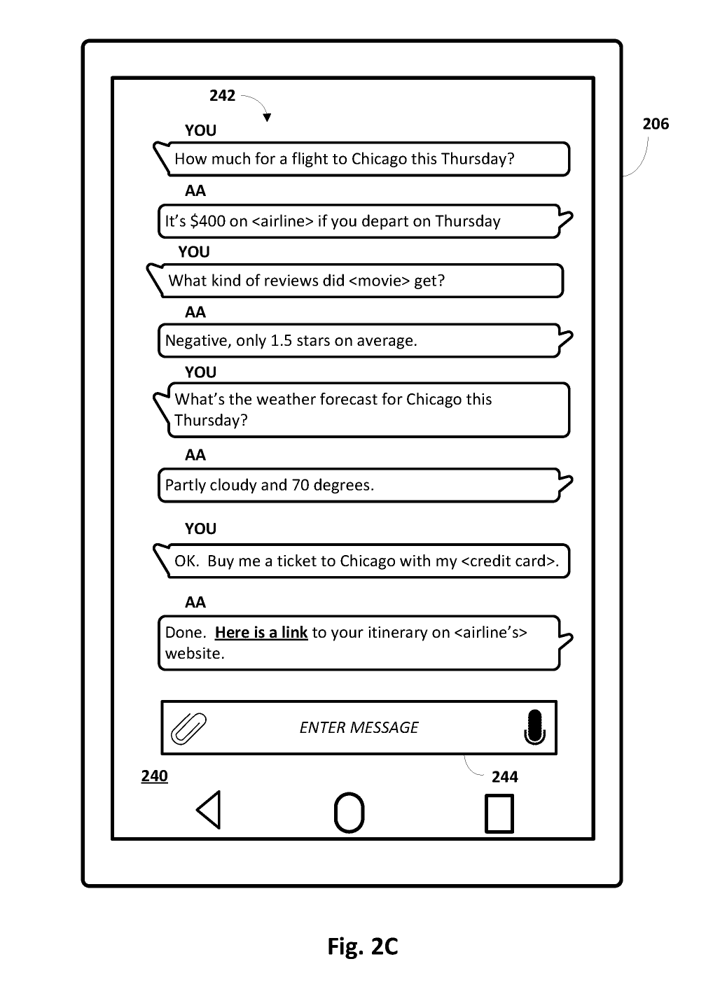

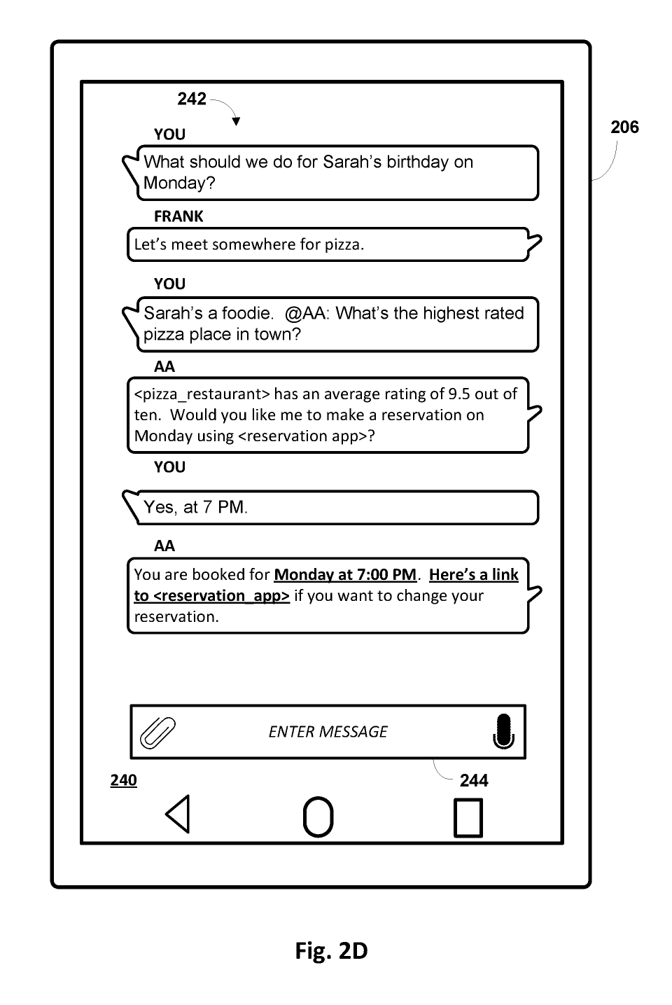

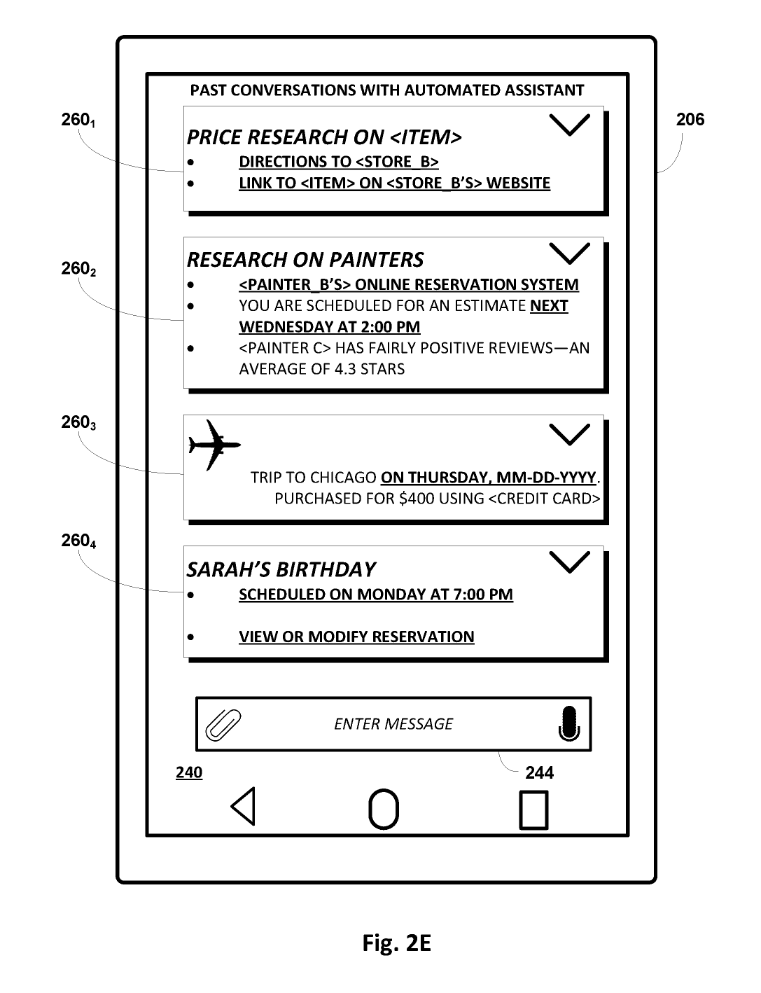

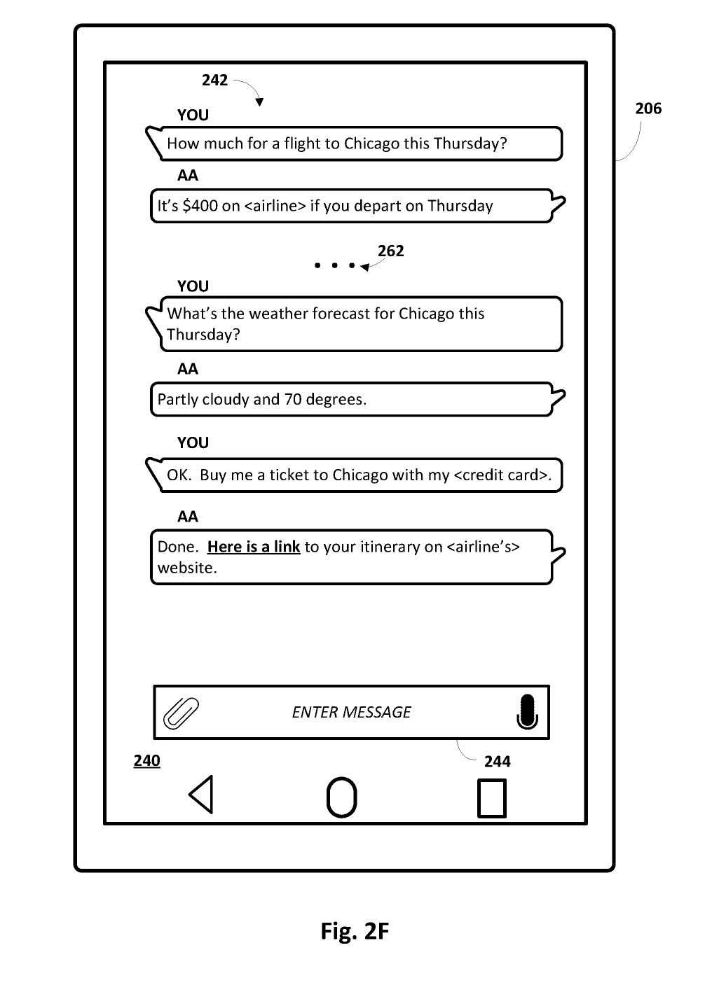

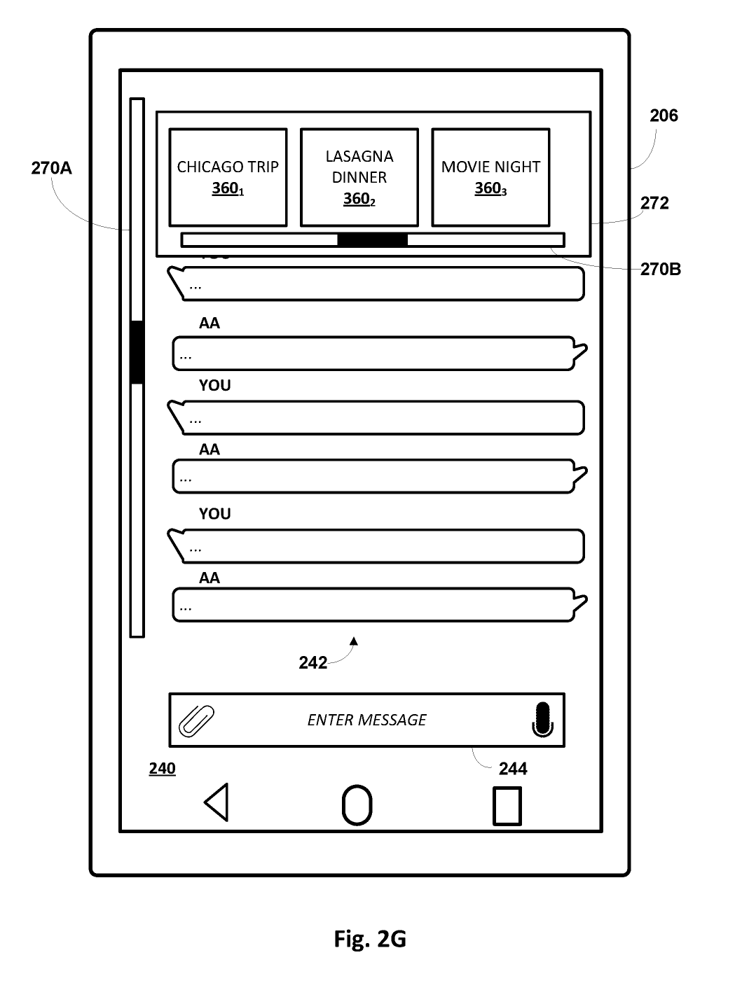

FIGS. 2A-D illustrate examples of four different human-to-computer dialog sessions (or “conversations”) between a user (“YOU” in the Figures) and an instance of automated assistant (120 in FIG. 1, not depicted in FIGS. 2A-D). A client device 206 in the form of a smart phone or tablet (but that is not meant to be limiting) includes a touchscreen 240. Rendered visually on touchscreen 240 is a transcript 242 of at least a portion of a human-to-computer dialog session between a user (“You” in FIGS. 2A-D) of client device 206 and an instance of automated assistant 120 executing on client device 206. Also provided is an input field 244 in which the user is able to provide natural language content, as well as other types of inputs such as images, sound, etc.

In FIG. 2A, the user initiates the human-to-computer dialog session with the question, “How much is <item> at <store_A>?” Terms contained in <brackets> are meant to be generic indicators of a particular (e.g., generic) type, rather than specific entities. Automated assistant 120 (“AA” in FIGS. 2A-D) performs any necessary searching and responds, “<store_A> is selling <item> for $39.95.” The user then asks, “Is anyone else selling it cheaper?” Automated assistant 120 performs any necessary searching and responds, “Yes, <store_B> is selling <item> for $32.99.” The user then asks,” “Can you give me directions to <store_B>?” Automated assistant 120 performs any necessary searches and other processing (e.g., determining the user's current location from a position coordinate sensor integral with client device 206) and responds, “Here is a link to your maps application with directions to <store_B> preloaded.” This link (the underlined text in FIG. 2A) may be a so-called “deep link” that when selected, causes client device 206 (or another client device, such as the user's vehicle navigation system) to open the map application pre-transitioned into a state in which directions to <store_B> are loaded. The user then asks, “What about online?” Automated assistant 120 responds, “Here is a link to <store_B′s> webpage offering <item> for sale with free shipping.”

FIG. 2B once again depicts client device 206 with touchscreen 240 and user input field 244, as well as a transcript 242 of a human-to-computer dialog session. In this example, the user (“You”) interacts with automated assistant 120 to research and ultimately book an appointment with a painter. The user initiates the human-to-computer dialog by typing and/or speaking (which may be recognized and converted to text) the natural language input, “Which painter has better reviews, <painter_A> or <painter_B>?” Automated assistant 120 (“AA”) responds, “<painter_B> has better reviews—an average of 4.5 starts—than <painter_A>, with an average of 3.7 stars.” The user then asks, “Does <painter_B> take online reservations for giving estimates?” After performing any necessary searching/processing, automated assistant 120 responds, “Yes, here is a link. It looks like <painter_B> has an opening next Wednesday at 2:00 PM.” (Once again the underlined text in FIG. 2B represents a selectable hyperlink).

The user then responds, “OK, book me. Are there any other painters in town with comparable reviews?” After performing any necessary searching/processing, automated assistant responds, “You are booked for next Wednesday at 2:00 PM. <painter_C> has fairly positive reviews—an average of 4.4 stars. Here's <painter_C′s> webpage.” The text “next Wednesday at 2:00 PM” is underlined in FIG. 2B to indicate that it is selectable to open a calendar entry with the pertinent details of the booking filled in. A link to <painter_C's> website is also provided.

In FIG. 2C, the user interacts with automated assistant 120 in a human-to-computer dialog to perform research related to, and ultimately procure a ticket associated with, air travel to Chicago. The user begins, “How much for a flight to Chicago this Thursday?” After any necessary searching and/or processing (e.g., including inquiring with various airlines about schedules and pricing), automated assistant 120 responds, “It's $400 on <airline> if you depart on Thursday.” The user then abruptly changes the subject by asking, “What kind of reviews did <movie> get?” After performing any necessary searching/processing, automated assistant 120 responds, “Negative, only 1.5 stars on average.”

The user then pivots the conversation back to the general topic of Chicago, asking, “What's the weather forecast for Chicago this Thursday?” After performing any necessary searching/processing, automated assistant 120 responds, “Partly cloudy and 70 degrees.” The user then states, “OK. Buy me a ticket to Chicago with my <credit card>” (it may be assumed that automated assistant 120 has one or of the user's credit cards on record). Automated assistant 120 performs any necessary searching/booking/processing and responds, “Done. Here is a link to your itinerary on <airline's> website.” Again, the underlined text in FIG. 2C represents a selectable link that the user may actuate to be taken (e.g., using a web browser installed on client device 206) to the airline's website. In other implementations, the user may be provided with a deep link to a predetermined state of an airline reservation application installed on client device 206.

In FIG. 2D, the user and another participant in the message exchange thread (“Frank”) organize an event related to their friend Sarah's birthday. The user begins, “What should we do for Sarah's birthday on Monday?” Frank responds, “Let's meet somewhere for pizza.” After pointing out that “Sarah is a foodie,” the user then addresses automated assistant 120 by asking, “@AA: What's the highest rated pizza place in town?” Automated assistant 120 performs any necessary searching/processing (e.g., scanning reviews of pizza restaurants nearby) and responds, “<pizza_restaurant> has an average rating of 9.5 out of ten. Would you like me to make a reservation on Monday using <reservation app>?” The user agrees: “Yes, at 7 PM.” After booking any necessary arrangements using a locally-installed restaurant reservation application, automated assistant 120 responds, “You are booked for Monday at 7:00 PM. Here's a link to <reservation_app> if you want to change your reservation.”

Any one of the conversations depicted in FIGS. 2A-D may include information, links, selectable elements, or other content that the user may wish to revisit at a later time. In many cases, all the messages exchanged in the conversations of FIGS. 2A-D may be stored in a chronological transcript (e.g., 124) that the user may revisit later. However, if the user interacts with automated assistant 120 extensively, chronological transcript 124 may be lengthy, as the messages depicted in FIGS. 2A-D may be interspersed among other messages forming parts of different conversations. Simply scrolling through chronological transcript 124 to locate a particular conversation of interest may be tedious and/or challenging, especially for a user with limited abilities to provide input (e.g., a physical disabled user, or a user engaged in another activity such as driving).

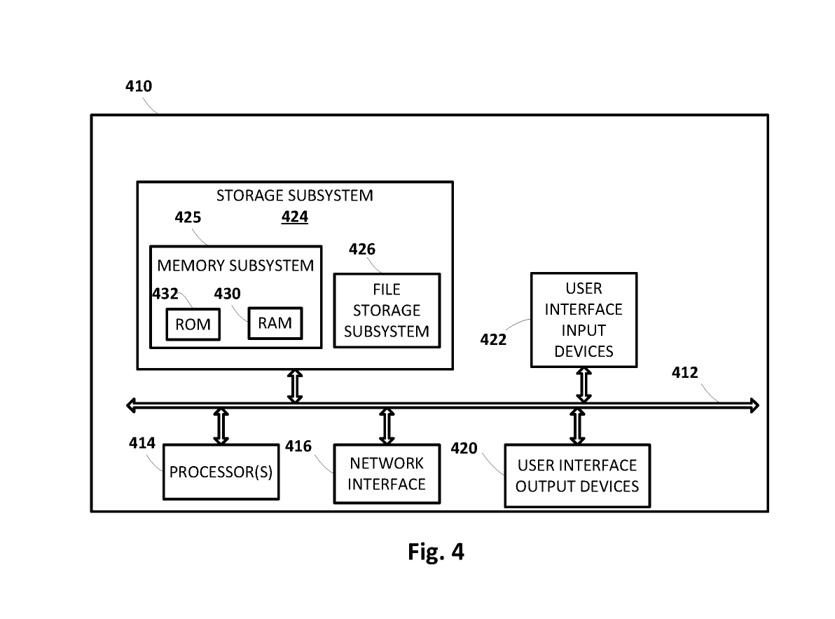

Accordingly, and as described above, messages may be grouped, e.g., by message organization module 126, into clusters or “conversations” based on various signals, shared attributes, etc. Conversational metadata may be generated, e.g., by message organization module 126, in association with each cluster. The conversational metadata may be used, e.g., by message presentation module 128, to generate selectable elements associated with each cluster/conversation. The user may then be able to more quickly scan through these selectable elements, rather than all of the messages underlying the conversations represented by these selectable elements, to locate a particular past conversation of interest. One non-limiting example is depicted in FIG. 4E.

FIG. 4E depicts client device 206 after it has rendered, on touchscreen 240, a series of selectable elements 260₁₋₄, each representing an underlying cluster of messages forming a distinct conversation. First selectable element 260₁ represents the conversation relating to price research depicted in FIG. 2A. Second selectable element 260₂ represents the conversation relating to painters depicted in FIG. 2B. Third selectable element 260₃ represents the conversation relating to the trip to Chicago depicted in FIG. 2C. Fourth selectable element 260₄ represents the conversation relating to organizing Sarah's birthday event depicted in FIG. 2D. Thus, it can be seen that the user is presented, in a single screen, with four selectable elements 260₁₋₄ that collectively represent numerous messages that the user otherwise would have had to scroll through chronological message transcript 124 to locate. In some implementations, the user may simply click or otherwise select (e.g., tap, double tap, etc.) a selectable element 260 to be presented with representations associated with at least one of the transcript messages. While selectable elements 260 are depicted in FIG. 4E as “cards” that appear on touchscreen 240, this is not meant to be limiting. In various implementations, the selectable elements may take other forms, such as collapsible threads, links, etc.

In FIG. 2E, each selectable element 260 conveys various information extracted from the respective underlying conversation. First selectable element 260₁ includes a title (“Price research on <item>”) that generally conveys the topic/task of that conversation, as well as two links that were incorporated into the conversation by automated assistant 120. In some implementations, any links or other components of interest (e.g., deep links) incorporated into an underlying conversation may be likewise incorporated (albeit in some cases in abbreviated form) into the selectable element 260 that represents the conversation. In some implementations, if a conversation includes a relatively large number of links, a particular number (e.g., user selected or determined based on available touchscreen real estate) of links that occurred most recently (i.e. last in time) may be incorporated into the corresponding selectable element 260. In some implementations, only those links which relate to a goal or outcome of a task (e.g., procuring an item, booking a ticket, organized event details) may be incorporated into the corresponding selectable element 260. In the case of first selectable element 260₁, there were only two links contained in the underlying conversation, so those two links have been incorporated into first selectable element 260₁. Notably, the first link is a deep link that when selected, opens a maps/navigation application installed on client device 206 with directions preloaded.

Second selectable element 260₂ also includes a title (“Research on painters”) that generally relates to the topic/task of the underlying conversation. Like first selectable element 260₁, second selectable element 260₂ includes multiple links that were incorporated into the conversation depicted in FIG. 2B. Selecting the first link opens a browser to a webpage that includes <painter_B's> online reservation system. The second link is selectable to open a calendar entry for the scheduled appointment. Also included in second selectable element 260₂ is an additional piece of information relating to <painter_C> which may be included, for instance, because it was the final piece of information incorporated into the conversation by automated assistant 120 (which may suggest it will be of interest to the user).

Third selectable element 260₃ includes a graphic of a plane indicating that it relates to a conversation related to a task of making travel arrangements and an outcome of booking a plane ticket. Had the conversation not resulted in procurement of a ticket, then third selectable element 260₃ may have included, for instance, a link that is selectable to complete procurement of the ticket. Third selectable element 260₃ also includes a link to the user's itinerary on the airline's website, along with the amount paid and the <credit card> used. As is the case with the other selectable elements 260, with third selectable element 260₃, message organization module 126 and/or message presentation module 128 have attempted to surface (i.e. present to the user) the most pertinent data points that resulted from the underlying conversation.

Fourth selectable element 260₄ includes the title “Sarah's birthday.” Fourth selectable element 260₄ also includes a link to a calendar entry for the party, and a deep link to a reservations app that was used to create the reservation. Selectable elements 260 may be sorted or ranked based on various signals. In some implementations, selectable elements 260 may be sorted chronologically, e.g., with the selectable elements representing the newest (or oldest) conversations at top. In other implementations, selectable elements 260 may be sorted based on other signals, such as outcome/goal/next step(s) (e.g., was there a purchase made?), number of messages in the conversation, number of participants in the conversation, task importance, task immediacy (e.g., conversations related to upcoming events may be ranked higher than conversations related to prior events), etc.

As noted above, in FIG. 4E, the user can select any of selectable elements 260₁₋₄ (in areas other than the links, on the v-shapes at top right of each element, etc.) to be presented with representations associated with each underlying conversation. However, the user may also click on or otherwise select the individual links to be taken directly to the corresponding destination/application, without having to view the underlying messages.

The conversations depicted in FIGS. 2A, 2B, and 2D were relatively self-contained conversations (mostly for purposes of clarity and brevity). However, this is not meant to be limiting. A single conversation (or cluster of related messages) need not necessary be part of a single human-to-computer dialog session. Indeed, a user may engage automated assistant 120 about a topic in a first conversation, engage automated assistant 120 in any number of other conversations about other topics in the interim, and then revisit the topic of the first conversation in a subsequent human-to-computer dialog. Nonetheless, these temporally-separated-yet-semantically-related messages may be organized into a cluster. That is one technical advantage provided by techniques described herein: temporally scattered messages that are semantically or otherwise related may be coalesced into a cluster or conversation that is easily retrievable by the user without having to provide numerous inputs (e.g., scrolling, keyword searching, etc.). Of course, in some implementations, messages also may be organized into clusters or conversations wholly or partially based on temporal proximity, session proximity (i.e., contained in the same human-to-computer dialog session, or in temporally proximite human-to-computer dialog sessions), etc.

FIG. 2F depicts one non-limiting example of what might be depicted by client device 206 after the user selects third selectable element 260₃. As noted above, the conversation represented by third selectable element 260₃ is depicted in FIG. 2C. That conversation included two messages (“What kind of reviews did <movie> get?” and “Negative, only 1.5 stars on average”) that were unrelated to the rest of the messages depicted in FIG. 2C, which related to scheduling the trip to Chicago. Consequently, in FIG. 2F, an ellipsis 262 is depicted to indicate that those messages that were unrelated to the underlying conversation have been omitted. In some implementations, the user may be able to select the ellipsis 262 in order to see those messages. Of course, other symbols may be used to indicate omitted intervening messages; the ellipsis is merely one example.

FIG. 2G depicts an alternative manner in which selectable elements 360_{1-N} may be presented to that of FIG. 2E. In FIG. 2G, the user is operating client device 206 to scroll through messages (intentionally left blank for brevity's and clarity's sakes) of transcript 242, specifically using a first, vertically-oriented scroll bar 270A. At the same time, a graphical element 272 is rendered that depicts selectable elements 360 that represent conversations that are currently visible on touchscreen 240. A second, horizontally-oriented scroll bar 270B, which alternatively may be operated by the user, indicates a relative location of the conversation represented by messages currently displayed on touchscreen. In other words, scroll bars 270A and 270B work together in unison: as the user scrolls scroll bar 270A down, scroll bar 270B moves right; as the user scrolls scroll bar 270A up, scroll bar 270B moves left. Likewise, as the user scrolls scroll bar 270B right, scroll bar 270A moves down, and as the user scrolls scroll bar 270B left, scroll bar 270A moves up.

In some implementations, a user may select (e.g., click, tap, etc.) a selectable element 360 to vertically scroll the messages so that the first message of the underlying conversation is presented at top. In some implementations, a user may perform various actions on clusters (or conversations) of messages by acting upon the corresponding selectable elements 360. For example, in some implementations, a user may be able to “swipe” a selectable element 360 in order to perform some action on the underlying messages en masse, such as deleting them, sharing them, saving them to a different location, flagging them, etc. While graphical element 272 is depicted superimposed over the messages, this is not meant to be limiting. In various implementations, graphical element 272 (or selectable elements 360 themselves) may be rendered on a portion of touchscreen 240 that is distinct or separate from that which contains the messages.

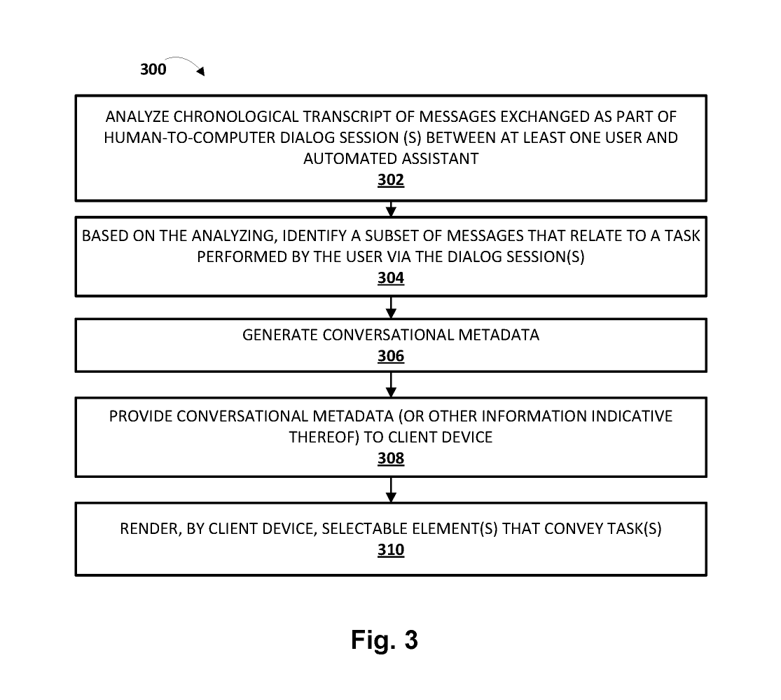

FIG. 3 depicts an example method 300 for practicing selected aspects of the present disclosure, in accordance with various implementations. For convenience, the operations of the flow chart are described with reference to a system that performs the operations. This system may include various components of various computer systems, including automated assistant 120, message organization module 126, message presentation module 128, etc. Moreover, while operations of method 300 are shown in a particular order, this is not meant to be limiting. One or more operations may be reordered, omitted or added.

At block 302, the system may analyze a chronological transcript of messages exchanged as part of one or more human-to-computer dialog sessions between at least one user and an automated assistant. As noted above, these human-to-computer dialog sessions can involve just a single user and/or may involve multiple users. The analysis may include, for instance, topic classifier 127 identifying topics of individual messages, topics of groups of temporally proximate messages, clustering messages by various words, clustering messages temporally, clustering messages spatially, etc.

At block 304, the system may identify, based on the analyzing, at least a subset (or “cluster” or “conversation”) of the chronological transcript of messages that relate to a task performed by the at least one user via the one or more human-to-computer dialog sessions. For example, the system may identify messages that when clustered form the distinct conversations depicted in FIGS. 2A-D.

At block 306, the system may generate, based on content of the subset of the chronological transcript of messages and the task, conversational metadata associated with the subset of the chronological transcript of messages. For example, the system may select a topic (or task) identified by topic classifier 127 as a title, and may select links and/or other pertinent pieces of data (e.g., first/last messages of the conversation), for incorporation into a data structure that may be stored in memory and/or transmitted to remote computing devices as a package.

At optional block 308, the system may provide the conversational metadata (or other information indicative thereof, such as XML, HTML, etc.) to a client device (e.g., 106, 206) over one or more networks. In some implementations in which operations 302-306 are performed at the client device, operation 308 may obviously be omitted. At block 310, the client computing device (e.g., 106, 206) may provide, via an output device associated with the client computing device, a selectable element that conveys the task or topic, as was depicted in FIGS. 2E and 2G. In various implementations, selection of the selectable element may cause the client computing device to present, via the output device, representations associated with at least one of the transcript messages related to the task or topic. These representations may include, for instance, the messages themselves, links extracted from the messages, etc.

FIG. 4 is a block diagram of an example computing device 410 that may optionally be utilized to perform one or more aspects of techniques described herein. In some implementations, one or more of a client computing device, automated assistant 120, and/or other component(s) may comprise one or more components of the example computing device 410.

Computing device 410 typically includes at least one processor 414 which communicates with a number of peripheral devices via bus subsystem 412. These peripheral devices may include a storage subsystem 424, including, for example, a memory subsystem 425 and a file storage subsystem 426, user interface output devices 420, user interface input devices 422, and a network interface subsystem 416. The input and output devices allow user interaction with computing device 410. Network interface subsystem 416 provides an interface to outside networks and is coupled to corresponding interface devices in other computing devices.

User interface input devices 422 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 410 to the user or to another machine or computing device.

Storage subsystem 424 stores programming and data constructs that provide the functionality of some or all of the modules described herein. For example, the storage subsystem 424 may include the logic to perform selected aspects of method 300, as well as to implement various components depicted in FIG. 1.

These software modules are generally executed by processor 414 alone or in combination with other processors. Memory 425 used in the storage subsystem 424 can include a number of memories including a main random access memory (RAM) 430 for storage of instructions and data during program execution and a read only memory (ROM) 432 in which fixed instructions are stored. A file storage subsystem 426 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 426 in the storage subsystem 424, or in other machines accessible by the processor(s) 414.

Bus subsystem 412 provides a mechanism for letting the various components and subsystems of computing device 410 communicate with each other as intended. Although bus subsystem 412 is shown schematically as a single bus, alternative implementations of the bus subsystem may use multiple busses.

Computing device 410 can be of varying types including a workstation, server, computing cluster, blade server, server farm, or any other data processing system or computing device. Due to the ever-changing nature of computers and networks, the description of computing device 410 depicted in FIG. 4 is intended only as a specific example for purposes of illustrating some implementations. Many other configurations of computing device 410 are possible having more or fewer components than the computing device depicted in FIG. 4.

In situations in which certain implementations discussed herein may collect or use personal information about users (e.g., user data extracted from other electronic communications, information about a user's social network, a user's location, a user's time, a user's biometric information, and a user's activities and demographic information, relationships between users, etc.), users are provided with one or more opportunities to control whether information is collected, whether the personal information is stored, whether the personal information is used, and how the information is collected about the user, stored and used. That is, the systems and methods discussed herein collect, store and/or use user personal information only upon receiving explicit authorization from the relevant users to do so.

For example, a user is provided with control over whether programs or features collect user information about that particular user or other users relevant to the program or feature. Each user for which personal information is to be collected is presented with one or more options to allow control over the information collection relevant to that user, to provide permission or authorization as to whether the information is collected and as to which portions of the information are to be collected. For example, users can be provided with one or more such control options over a communication network. In addition, certain data may be treated in one or more ways before it is stored or used so that personally identifiable information is removed. As one example, a user's identity may be treated so that no personally identifiable information can be determined. As another example, a user's geographic location may be generalized to a larger region so that the user's particular location cannot be determined. In the context of the present disclosure, any relationships captured by the system, such as a parent-child relationship, may be maintained in a secure fashion, e.g., such that they are not accessible outside of the automated assistant using those relationships to parse and/or interpret natural language input.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method, comprising:
analyzing, by one or more processors, a chronological transcript of messages exchanged as part of one or more human-to-computer dialog sessions between at least one user and an automated assistant;
identifying, by one or more of the processors, based on the analyzing, at least a subset of the chronological transcript of messages that relate to a task performed by the at least one user via the one or more human-to-computer dialog sessions; and
generating, by one or more of the processors, based on content of the subset of the chronological transcript of messages and the task, conversational metadata associated with the subset of the chronological transcript of messages;
wherein the conversational metadata causes a client computing device to provide, via an output device associated with the client computing device, a selectable element that conveys the task, wherein selection of the selectable element causes the client computing device to present, via the output device, representations associated with at least one of the transcript messages related to the task.

2. The method of claim 1, further comprising identifying, by one or more of the processors, based on content of the subset of the chronological transcript of messages, an outcome of the task, wherein the selectable element conveys the outcome of the task.

3. The method of claim 2, wherein the outcome of the task comprises procurement of an item.

4. The method of claim 2, wherein the task comprises organizing an event.

5. The method of claim 4, wherein the outcome of the task comprises details associated with the organized event.

6. The method of claim 1, further comprising identifying, by one or more of the processors, based on content of the subset of the chronological transcript of messages, a next step for completing the task, wherein the selectable element conveys the next step.

7. The method of claim 1, wherein identifying the subset of the chronological transcript of messages is based on an outcome of the task.

8. The method of claim 1, wherein identifying the subset of the chronological transcript of messages is based on timestamps associated with individual messages of the chronological transcript of messages.

9. The method of claim 1, wherein the selectable element comprises a collapsible thread that expands on selection to provide the subset of the chronological transcript of messages.

10. The method of claim 1, wherein the selectable element comprises an individual message of the subset, and selection of the individual message of the subset causes one or more other individual messages of the subset to be presented in a first manner that is visually distinct from a second manner in which other messages of the chronological transcript of messages are presented.

11. The method of claim 1, wherein the representations comprise icons associated with or contained in the subset of the chronological transcript of messages.

12. The method of claim 1, wherein the representations comprise one or more hyperlinks contained in the subset of the chronological transcript of messages.

13. The method of claim 1, wherein the representations comprise the subset of the chronological transcript of messages.

14. The method of claim 13, wherein messages of the subset of the chronological transcript of messages are presented chronologically.

15. The method of claim 13, wherein messages of the subset of the chronological transcript of messages are presented in an order or relevance.

16. A system comprising one or more processors and memory operably coupled with the one or more processors, wherein the memory stores instructions that, in response to execution of the instructions by one or more processors, cause the one or more processors to:
analyze a chronological transcript of messages exchanged as part of one or more human-to-computer dialog sessions between at least one user and an automated assistant;
identify, based on the analyzing, at least a subset of the chronological transcript of messages that relate to a task performed by the at least one user via the one or more human-to-computer dialog sessions; and
generate, based on content of the subset of the chronological transcript of messages and the task, conversational metadata associated with the subset of the chronological transcript of messages;
wherein the conversational metadata causes a client computing device to provide, via an output device associated with the client computing device, a selectable element that conveys the task, wherein selection of the selectable element causes the client computing device to present, via the output device, representations associated with at least one of the transcript messages related to the task.

17. The system of claim 16, further comprising instructions to identify, by one or more of the processors, based on content of the subset of the chronological transcript of messages, an outcome of the task.

18. The system of claim 17, wherein the selectable element conveys the outcome of the task.

19. The system of claim 16, wherein identification of the subset of the chronological transcript of messages is based on an outcome of the task.

20. At least one non-transitory computer-readable medium comprising instructions that, in response to execution of the instructions by one or more processors, cause the one or more processors to perform the following operations:
analyzing a chronological transcript of messages exchanged as part of one or more human-to-computer dialog sessions between at least one user and an automated assistant;
identifying, based on the analyzing, at least a subset of the chronological transcript of messages that relate to a task performed by the at least one user via the one or more human-to-computer dialog sessions; and
generating, based on content of the subset of the chronological transcript of messages and the task, conversational metadata associated with the subset of the chronological transcript of messages;
wherein the conversational metadata causes a client computing device to provide, via an output device associated with the client computing device, a selectable element that conveys the task, wherein selection of the selectable element causes the client computing device to present, via the output device, representations associated with at least one of the transcript messages related to the task.
